(19) United States
(12) Patent Application Publication
(10) Pub. No.: US 2007/0275197 A1
(43) Pub. Date: Nov. 29, 2007

(54) Resin composition and multilayer structure

(76) Inventors: Edgard Chow, Pearland, TX (US); Hiroyuki Shimo, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/440,112

(22) Filed: May 25, 2006

(51) Int. Cl. B32B 1/02; B32B 27/00

(52) U.S. Cl. 428/35.7; 428/500; 524/502; 524/417

(57) ABSTRACT

To provide a resin composition including: an ethylene-vinyl alcohol copolymer (A) having an ethylene content of from 15 to 65 mol % and a saponification degree of at least 95 mol %, a phosphoric acid salt (B) which can form a hydrate, and a conjugated polyene compound (C) having a boiling point of at least 150° C., wherein the resin composition comprises from 50 to 99 parts by weight of (A), from 1 to 50 parts by weight of (B) and from 0.00001 to 1 parts by weight of (C), based on 100 parts by weight of the total amounts of (A) and (B). This resin composition excels in gas barrier property and also in moisture resistance at high temperatures and high humidities. Therefore, it is suitable for food packaging containers to be retorted.

### BACKGROUND OF THE INVENTION

1. Field of the Invention

The present invention relates to a resin composition comprising an ethylene-vinyl alcohol copolymer, which, hereinafter, is also referred to as “EVOH”, a phosphoric acid salt, and a conjugated polyene compound. Multilayer structures having a layer of the resin composition are suitably used as packaging containers to be retorted.

2 Description of the Related Art

Materials of containers to be used for retorting foods such as vegetables and seafood are still dominated by glass, metal and metal foil. Recently, however, rigid or semi-rigid plastic containers have come to be commonly used as containers to be used for retorting other types of food such as soups and pet food. Ethylene-vinyl alcohol copolymer (EVOH) has been adopted as a barrier resin for such plastic containers due to its good processability and excellent gas barrier properties.

One known inherent weakness of EVOH, related to its chemical structure, is the fact that its gas barrier properties are greatly diminished at a relative humidity of 85% or higher. That is to say, water acts as a plasticizer to EVOH, weakens the hydrogen bonding in the amorphous region of EVOH, increases the amount of free volume, and ultimately increases the gas diffusivity through the polymer matrix. When such a phenomenon occurs after typical steam retort treatment where packages are processed at temperature of from 110 to 132° C. for periods of from 15 to 80 minutes, EVOH comes to undergo a term now coined in packaging industry as “retort shock”. During a retort shock, the oxygen transmission rate of the EVOH dramatically increases and for that period of time the food product suffers from a great damage due to oxidation degradation. Packaging and food engineers have studied and designed, by various approaches, packaging containers for food protection with good storage stability. For example, oxygen permeation through a lid is countermeasured by use of a double seamed metal lid or a thick aluminum/polymer lamination.

In the use of EVOH, the oxygen permeability of the container is maintained appropriately by design techniques intended to keep the EVOH as dry as possible. Firstly, the use of relatively thick polypropylene sidewalls was studied. For some applications, sidewalls with a thickness up to 45 mils (1143 μm) have been adopted. Secondly, the use of a relatively thick layer of EVOH was studied and multilayer structures with as much as 20% by weight of EVOH layer were placed in the market. Thirdly, multilayer structures with an adhesive resin layer containing a desiccant to keep the EVOH dry after the retort treatment were placed in the market. The third approach is disclosed, for example, in U.S. Pat. No. 4,407,897 A.

U.S. Pat. No. 4,792,484 A discloses a composition comprising a matrix of an EVOH having dispersed therein a granular drying agent in a particulate state, wherein among the dispersed granular inorganic drying agent, the volume-area average diameter of granules with a long diameter of at least 10 μm is not greater than 30 μm and the weight ratio of saponification product of the ethylene-vinyl acetate copolymer to the inorganic drying agent ranges from 97:3 to 50:50. As a drying agent used herein, a phosphoric acid salt capable of forming a hydrate is disclosed. Multilayer structures having a layer of the resin composition are also disclosed. The multilayer structures are disclosed to be suitable as containers for retort treatment.

Incidentally, in processes for producing containers for retort treatment such as thermoformed containers, it is a usual practice to recover punch wastes or defective molded products generated during a process, pulverize them and reuse the resulting material for container production. Hence, in many cases, multilayer structures having a layer of a regrind composition recycled are produced. Therefore, it is very important that it is possible to produce a multilayer structure having a regrind layer without any troubles.

However, when a granular desiccant is incorporated into a normal EVOH as disclosed in U.S. Pat. No. 4,792,484, there is a problem that the thermal stability of a resin composition recycled will be impaired. For example, it was impossible to avoid occurrence of coloring, gelation, or black spots in a multilayer structure having a regrind composition layer.

U.S. Pat. No. 5,744,547 A discloses a process for producing an ethylene-vinyl acetate copolymer, which comprises, after copolymerization of vinyl acetate and ethylene to form an ethylene-vinyl acetate copolymer, adding a conjugated polyene compound having a boiling point of at least 20° C. and thereafter removing unreacted vinyl acetate. The resulting ethylene-vinyl acetate copolymer is then saponified to obtain an EVOH resin composition containing from 0.000001 to 1% by weight of the conjugated polyene compound. It is disclosed that this EVOH resin composition can be molded while suffering from little coloring and little generation of gel-like agglomerates. U.S. Pat. No. 5,744,547 A discloses that a partial salt of phosphoric acid such as sodium dihydrogenphosphate and potassium dihydrogenphosphate may be added. This approach includes incorporation of a slight amount of salt included in an aqueous solution or the like and subsequent drying. Thus, incorporation of a relatively large amount of phosphoric acid salt capable of forming a hydrate is not disclosed.

U.S. Pat. No. 4,082,854 A discloses a packaging material having an improved gas permeation resistance, the packaging material comprising a layer of EVOH or a resin composition containing EVOH, wherein the EVOH has a main endothermic peak corresponding to the melting point of the EVOH and a subsidiary endothermic peak at a temperature lower than the melting point of the EVOH. It is disclosed that when an EVOH is heat treated of at a predetermined temperature not higher than the melting point of the EVOH, a subsidiary endothermic peak appears and the gas barrier properties are improved. However, the amount of heat absorbance of the endothermic peak is much smaller than the amount of heat absorbance of the main endothermic peak.

### SUMMARY OF THE INVENTION

The present invention was made in order to solve the problems mentioned above. An object of the present invention is to provide an EVOH resin composition which excels in gas barrier property, moisture resistance at high temperatures and high humidities, and thermal stability during melt molding. Another object is to provide a multilayer structure having a layer of such a resin composition, the multilayer structure being prevented from deterioration in gas barrier properties even during retort treatment.

The above-mentioned objects can be solved by providing a resin composition comprising: an ethylene-vinyl alcohol copolymer (A) having an ethylene content of from 15 to 65 mol % and a saponification degree of at least 95 mol %, a phosphoric acid salt (B) which can form a hydrate, and a conjugated polyene compound (C) having a boiling point of at least 150° C., wherein the resin composition comprises from 50 to 99 parts by weight of (A), from 1 to 50 parts by weight of (B) and from 0.00001 to 1 parts by weight of (C), based on 100 parts by weight of the total amounts of (A) and (B).

In this constitution, it is desirable that the phosphoric acid salt (B) comprises a powder containing 97% by volume or more of particles having a particle diameter of 16 μm or less. It is also desirable that a weight loss onset temperature of the phosphoric acid salt (B) measured by thermogravimetric analysis is at least 245° C.

Moreover, it is also desirable that when a multilayer structure formed by sandwiching a layer of the resin composition having a thickness of 2 mils between polypropylene layers having a thickness of 9 mils is conducted to retort treatment at 121° C. for 60 minutes, in a differential scanning calorimetry (DSC) measurement of the layer of the resin composition after the retort treatment, the ratio (ΔH₂/ΔH₁) of the amount of heat absorbance (ΔH₂) of a second endothermic peak appearing between 80° C. and 135° C. to the amount of heat absorbance (ΔH₁) of a first endothermic peak corresponding to the melt of crystals of the ethylene-vinyl alcohol copolymer (A) is 3 or more.

One desirable embodiment of the present invention is a multilayer structure comprising a layer of the resin composition mentioned above, and layers of at least one thermoplastic resin selected from the group consisting of polyolefins, polystyrenes, polyesters, polyamides, polyvinyl chlorides, polyvinylidene chlorides, polyvinyl acetates and polyacrylonitriles, arranged on both sides of the layer of the resin composition. In this embodiment, it is desirable that the layers of a thermoplastic resin selected from the group consisting of polyolefins, polystyrenes, polyesters, polyamides, polyvinyl chlorides, polyvinylidene chlorides, polyvinyl acetates and polyacrylonitriles be arranged on both sides of the layer of the resin composition via an adhesive resin layer.

In the multilayer structure, it is desirable that, in a differential scanning calorimetry (DSC) measurement of the resin composition layer following retort treatment of the layer at 121° C. for 60 minutes, the ratio (ΔH₂/ΔH₁) of the amount of heat absorbance (ΔH₂) of a second endothermic peak appearing between 80 and 135° C. to the amount of heat absorbance (ΔH₁) of a first endothermic peak corresponding to the melt of crystals of the ethylene-vinyl alcohol copolymer (A) be 3 or more. It is also desirable that an oxygen transmission rate after a lapse of 24 hours from retort treatment at 121° C. for 60 minutes is not more than 10 times as much as an oxygen transmission rate before the retort treatment.

One desirable embodiment of the present invention is a recycled resin composition prepared by melt-kneading the multilayer structure mentioned above. Another desirable embodiment of the present invention is a packaging container comprising the multilayer structure mentioned above. Still another desirable embodiment of the present invention is a retort package comprising the packaging container filled with contents.

The objects previously mentioned are solved also by providing a method for producing the resin composition mentioned above, the method comprising adding a phosphoric acid salt (B) which can form a hydrate to a resin composition comprising an ethylene-vinyl alcohol copolymer (A) having an ethylene content of from 15 to 65 mol % and a saponification degree of at least 95 mol % and a conjugated polyene compound (C) having a boiling point of at least 150° C., and melt-kneading them.

In this constitution, it is desirable that the phosphoric acid salt (B) comprises a powder containing 97% by volume or more of particles having a particle diameter of 16 μm or less, more preferably 13 μm or less, and even more preferably 10 μm or less. Further, it is desirable that the method further comprises a step of grinding the phosphoric acid salt (B) before the melt-kneading or a step of drying the phosphoric acid salt (B) before the melt kneading. In the above-mentioned method, it is desirable that the temperature during the melt-kneading is from 190 to 260° C.

The resin composition of the present invention excels in gas barrier property and also in moisture resistance at high temperatures and high humidities. Therefore, because multilayer structures comprising a layer of the resin composition of the present invention show suppressed deterioration in gas barrier properties after retort treatment, they are suited for, for example, packaging containers of foods whose oxidation degradation is required to be prevented. Further, because the resin composition of the present invention has excellent thermal stability, it is possible to inhibit coloring, gelation or black spot formation effectively during melt molding in spite of inclusion of a certain amount of phosphoric acid salt. It, therefore, is possible to obtain molded articles with good quality even when multilayer structures comprising a layer of the resin composition of the present invention are recovered and melt-kneaded again.

### BRIEF DESCRIPTION OF THE DRAWINGS

FIG. 1 is a graph showing the change of oxygen transmission rate with time after retort treatment.

FIG. 2 is a graph showing the dependency of oxygen transmission rate on water uptake.

FIG. 3 is a DSC chart measured when retort treatment was conducted.

### DESCRIPTION OF THE PREFERRED EMBODIMENTS

The resin composition of the present invention is a resin composition comprising an ethylene-vinyl alcohol copolymer (EVOH) (A) having an ethylene content of from 15 to 65 mol % and a saponification degree of at least 95 mol %, a phosphoric acid salt (B) which can form a hydrate, and a conjugated polyene compound (C) having a boiling point of at least 150° C.

As mentioned above, by incorporating a phosphoric acid salt (B) to an EVOH (A), the thermal stability of the resulting resin composition is greatly diminished. Particularly, when the resin composition is recycled, this tendency has been apparent. It has been found that the deterioration in heat stability is inhibited effectively by further incorporating thereinto of a conjugated polyene compound (C) having a boiling point of 150° C. or higher even when a phosphoric acid salt (B) is incorporated.

The ethylene content in the EVOH (A) used in the present invention is from 15 to 65 mol %. When the ethylene content is less than 15 mol %, the resin composition will have an insufficient moisture resistance and it is impossible to use such a resin composition particularly under conditions of high temperatures and high humidities such as retort treatment. The ethylene content is preferably 20 mol % or more, and more preferably 25 mol % or more. When the ethylene content is over 65 mol %, the resin composition will have insufficient gas barrier properties and, therefore, can not be used for applications where high gas barrier properties are required. The ethylene content is preferably not more than 50 mol %, and more preferably not more than 40 mol %.

The saponification degree of the EVOH (A) is at least 95 mol %. A low saponification degree results in a low crystallinity of EVOH, which leads to low gas barrier properties and greatly diminished thermal stability at the time of melt-molding. The saponification degree is preferably not less than 98 mol %, and more preferably not less than 99 mol %.

The melt flow rate (at 210° C. under a load of 2160 g) of the EVOH (A) is preferably from 0.1 to 50 g/10 min. When the melt flow rate is less than 0.1 g/10 min, it may become difficult to conduct melt-molding and also become difficult to mix the phosphoric acid salt (B) uniformly. The melt flow rate is preferably not less than 0.5 g/10 min, and more preferably not less than 1 g/10 min. On the other hand, when the melt flow rate is over 50 g/10 min, it will become difficult to conduct extrusion and the strength of the EVOH (A) layer will be diminished. The melt flow rate is more preferably not more than 20 g/10 min, and even more preferably not more than 10 g/10 min.

The phosphoric acid salt (B) which can form a hydrate is a substance which absorbs moisture by forming a hydrate, in other words, a substance which serves as a desiccant. Therefore, a substance capable of forming a hydrate by absorbing moisture as water of crystallization is preferably used. Many phosphoric acid salts form hydrates containing a plurality of water molecules as water of crystallization and, therefore, they can absorb a large amount of water per unit weight. For this reason, they are suitably used for the resin composition of the present invention. Moreover, the number of molecules of water of crystallization which the phosphoric acid salt can contain often increases in steps as the humidity increases. Therefore, the phosphoric acid salt can absorb water gradually with change of humidity environment.

Examples of the phosphoric acid salt (B) to be used in the present invention include sodium phosphate (Na₃PO₄), disodium hydrogenphosphate (Na₂HPO₄), sodium dihydrogenphosphate (NaH₂PO₄), sodium polyphosphate, lithium phosphate, dilithium hydrogenphosphate, lithium dihydrogenphosphate, lithium polyphosphate, potassium phosphate, dipotassium hydrogenphosphate, potassium dihydrogenphosphate, potassium polyphosphate, calcium phosphate (Ca₃(PO₄)₂), calcium hydrogenphosphate (CaHPO₄), calcium dihydrogenphosphate (Ca(H₂PO₄)₂), calcium polyphosphate, ammonium phosphate, diammonium hydrogenphosphate, ammonium dihydrogenphosphate, and ammonium polyphosphate. The polyphosphates include diphosphates (pyrophosphates), triphosphates (tripolyphosphates), etc. Among such phosphates (B), anhydrous salts with no water of crystallization are preferred. Sodium phosphate, disodium hydrogenphosphate, and sodium dihydrogenphosphate are preferred.

The investigations by the present inventors have revealed that inclusion of impurities in a phosphoric acid salt (B) affects the thermal stability of a resulting resin composition. Such inclusion of impurities occurs during the process of the production of the phosphoric acid salt (B), etc. Therefore, the choice of the phosphoric acid salt (B) to be used is important. There are many possible methods of screening phosphoric acid salts (B) appropriate as a raw material of the resin composition of the present invention. For example, one of such methods comprises melt-kneading of an EVOH and a phosphoric acid salt (B) for a certain period of time in a batch type rotor device like a Brabender followed by visual evaluation of the color of the resulting resin composition.

However, a method which is preferred because of its simplicity and convenience is thermogravimetric analysis. The weight loss onset temperature (decomposition onset temperature) of an EVOH measured by thermogravimetric analysis is as low as about 300° C. when the EVOH has a low ethylene content. Therefore, a generally recommended melt processing temperature of an EVOH is reported to be 245° C. or lower. In order to prevent a phosphoric acid salt (B) from decomposing in an extruder, the weight loss onset temperature of the phosphoric acid salt (B) measured by thermogravimetric analysis is preferably 245° C. or higher. When the weight loss onset temperature is lower than 245° C., the thermal stability of the resin composition of the present invention may be impaired and foaming and the like may occur. The weight loss onset temperature of the phosphoric acid salt (B) is more preferably 260° C. or higher.

The effect of impurities in the phosphoric acid salt (B) can also be judged on the basis of the acidity of the salt. For example, although disodium hydrogenphosphate is particularly preferably used among all types of phosphoric acid salt (B), 1% by weight aqueous solutions of commercial grade disodium hydrogenphosphates have a pH within the range of from 8.7 to 9.6. The pH of the 1% by weight aqueous solution of a disodium hydrogenphosphate used for the resin composition of the present invention is preferably within the range of from 9 to 9.4. A disodium hydrogenphosphate having a pH within this range seems to contain acidic impurities or alkali impurities in small amounts and therefore can afford resin compositions with good thermal stabilities. A more preferable lower limit of the pH is 9.1, and a more preferable upper limit is 9.35.

The phosphoric acid salt (B) used in the present invention is typically in a powder form. Powders of commercially available phosphoric acid salts (B) have an average particle diameter of from 15 to 25 μm and the size of the largest particle included is from 40 to 100 μm. Use of a powder including such large particles may result in unsatisfactory gas barrier properties of a layer of the resin composition of the present invention. The investigations by the present inventors have revealed that inclusion of particles larger than the thickness of an EVOH resin composition layer tends to greatly diminish gas barrier properties. Multilayer containers including EVOH have applications in which the containers have EVOH layers as thin as about 20 μm.

Therefore, a powder of the phosphoric acid salt (B) used in the present invention preferably includes 97% by volume or more of particles having a particle diameter of 16 μm or less, more preferably includes 97% by volume or more of particles having a particle diameter of 13 μm or less, and even more preferably includes 97% by volume or more of particles having a particle diameter of 10 μm or less. It is possible to measure such a particle size distribution using a particle size distribution analyzer such as a Coulter counter.

Although the method for producing the powder with such a particle size distribution is not particularly limited, it is desirable to grind a commercially available powder of a phosphoric acid salt (B). As a device for the grinding, a jet mill, a ball mill, an impact pulverizer, and the like may be used. In particular, a jet mill, especially a fluidized bed jet mill is suitably used. It is desirable that particles are ground through their collision caused by collision of opposing jet air flows in a fluidized bed jet mill. This makes it possible to prevent contamination of metal. This is important because impurities contained in a phosphoric acid salt (B) gives a large effect on the thermal stability of the resin composition of the present invention as described previously. Further, the grinding device preferably has a classifier built therein. The built-in classifier preferably is a multi-wheel classifier, which can yield a powder with a sharp particle size distribution efficiently.

It is desirable that a phosphoric acid salt (B) is dried prior to its melt-kneading with an EVOH (A). The drying temperature is preferably from 60 to 120° C. In the case where the above-mentioned grinding operation is performed, it is permissible to dry the salt first, grind the dried salt, and then melt-knead the ground salt with an EVOH (A) or it is also permissible to grind the salt first, dry the ground salt, and then melt-knead the dried salt with an EVOH (A). Furthermore, it is also permissible to perform grinding and drying simultaneously.

The conjugated polyene compound (C) used in the present invention is a compound having a structure comprising carbon-carbon double bonds and carbon-carbon single bonds alternately, wherein the number of carbon-carbon double bonds is at least 2, in other words, there are so-called conjugated carbon-carbon double bonds. The conjugated polyene compound (C) may be a conjugated diene with a structure comprising two carbon-carbon double bonds and one carbon-carbon single bond alternately, or may be a conjugated triene with a structure comprising three carbon-carbon double bonds and two carbon-carbon single bonds alternately, or may be a conjugated polyene compound with a structure comprising four or more carbon-carbon double bonds and three or more carbon-carbon single bonds alternately. An olefin conjugated with an aromatic ring, which has a structure where one double bond is linked to an aromatic ring via a carbon-carbon single bond is also included in the conjugated polyene compound (C) to be used in the present invention. It is noted that polylenes having 7 or less conjugated carbon-carbon double bonds are preferred because polyenes having 8 or more conjugated carbon-carbon double bonds are colored themselves. Furthermore, a plurality of conjugated double bond units composed of two or more carbon-carbon double bonds such as those mentioned above may be contained in one molecule without conjugating each other. For example, compounds having three conjugated trienes in each molecule like tung oil are included in the conjugated polyene compound (C) in the present invention.

Further, the conjugated polyene compound (C) may have, in addition to the conjugated double bonds composed of two or more carbon-carbon double bonds, other functional groups such as carboxyl group and its salt, hydroxyl group, ester group, carbonyl group, ether group, amino group, imino group, amide group, cyano group, diazo group, nitro group, sulfone group, sulfoxide group, sulfide group, thiol group, sulfonic acid group and its salt, phosphoric acid group and its salt, phenyl group, halogen atom, double bond and triple bond. Such functional groups may be linked directly to a carbon atom in conjugated double bonds or may be linked to a position apart from conjugated double bonds. Therefore, a multiple bond in a functional group may be located on a position where the multiple bond can be conjugated with the conjugated double bonds. For example, 1-phenylbutadiene having a phenyl group, sorbic acid having a carboxyl group, and the like are included in the conjugated polyene compound (C) in the present invention.

It is noted that even though a compound has two or more carbon-carbon double bonds, if the compound does not have a structure where the double bonds can be conjugated by being linked with a carbon-carbon single bond alternately, it is not included in the conjugated polyene compound (C) in the present invention. Therefore, compounds having two or more non-conjugated carbon-carbon double bonds like geraniol and squalene are not included in the conjugated polyene compound (C) in the present invention. Further, compounds having a structure where one carbon-carbon double bond and one carbon-hetero atom double bond are conjugated via one carbon-carbon single bond are not included in the conjugated polyene compound (C) in the present invention. The hetero atom referred to herein includes a nitrogen atom, a sulfur atom, phosphorus atom, etc. as well as an oxygen atom mentioned above.

It is important that the conjugated polyene compound (C) used in the present invention has a boiling point of 150° C. or higher. Conjugated polyene compounds having a boiling point lower than 150° C. can not produce effects of the present invention because such compounds will deteriorate the color tone of resulting resin compositions and will cause more gels or black spots in comparison to compounds having a boiling point of 150° C. or higher. They are not preferred also from a food sanitation point of view because they easily diffuse during retort treatment.

Specific examples of the conjugated polyene compound (C) in the present invention include conjugated dienes having a conjugated structure comprising two carbon-carbon double bonds such as myrcene, farnesene, sorbic acid, sorbic esters and sorbic acid salts; conjugated trienes having a conjugated structure comprising three carbon-carbon double bonds such as eleostearic acid and tung oil; conjugated polyenes having a conjugated structure comprising four or more carbon-carbon double bonds such as retinol; and olefins conjugated with an aromatic ring such as 2,4-diphenyl-4-methyl-1-pentene. Regarding compounds having two or more stereoisomers like myrcene and farnesene, any stereoisomer may be used. Two or more compounds may be used as the conjugated polyene compound (C). Further, a compound other than the conjugated polyene compound (C) may be added together with or separately.

Such a conjugated polyene compound (C) is added during the process of producing the EVOH (A). The method for producing the EVOH (A) will be described later.

The compounding ratio of the EVOH (A), phosphoric acid salt (B) and conjugated polyene compound (C) in the resin composition of the present invention is from 50 to 99 parts by weight of (A), from 1 to 50 parts by weight of (B) and from 0.00001 to 1 part by weight of (C), based on 100 parts by weight of the total amounts of (A) and (B).

In the resin composition of the present invention, the EVOH (A) forms a matrix as a main component and thereby gas barrier properties are secured. When the content of the phosphoric acid salt (B) is less than 1 part by weight based on 100 parts by weight of the total amounts of (A) and (B), the moisture resistance, especially the moisture resistance at high temperatures and high humidities, of the resin composition is diminished. The content of the phosphoric acid salt (B) is preferably not less than 5 parts by weight, more preferably not less than 10 parts by weight, and even more preferably not less than 15 parts by weight. When the content of the phosphoric acid salt (B) is over 50 parts by weight based on 100 parts by weight of the total amounts of (A) and (B), gas barrier properties of the resin composition are diminished. The content of the phosphoric acid salt (B) is preferably not more than 40 parts by weight, and more preferably not more than 30 parts by weight.

When the content of the conjugated polyene compound (C) is less than 0.00001 parts by weight based on 100 parts by weight of the total amounts of (A) and (B), the thermal stability of the resin composition is diminished, and occurrence of coloring, gelation, or black spots becomes significant. The content of the conjugated polyene compound (C) is preferably not less than 0.0001 parts by weight, and more preferably not less than 0.001 parts by weight. On the other hand, in view of the fact that the resin composition is widely used for packaging containers, the cases where the content of the conjugated polyene compound (C) is over 1 part by weight based on 100 parts by weight of the total amounts of (A) and (B) are not necessarily favorable because of problems such as odor generation and bleeding out. The content of the conjugated polyene compound (C) is preferably not more than 0.5 parts by weight, and more preferably not more than 0.2 parts by weight.

The following is a description regarding the method for producing the resin composition of the present invention. Firstly, the synthesis process of the EVOH (A) is described. The EVOH (A) can be prepared by a known method comprising copolymerizing ethylene and a vinyl ester using a radical initiator and then saponifying the resulting copolymer in the presence of an alkaline catalyst. In this process, after the copolymerization of ethylene and the vinyl ester, a conjugated polyene compound (C) is added and then saponification is performed.

Examples of the vinyl ester include vinyl acetate, vinyl propionate, vinyl pivalate, vinyl caprate and vinyl benzoate. Among such vinyl esters, only one ester may be used and two or more esters may also be used in combination. In particular, vinyl acetate is preferred.

Representative polymerization conditions are as follows.

Solvent: Although alcohols are preferred, organic solvents which can dissolve ethylene, vinyl acetate and ethylene-vinyl acetate copolymers, e.g., dimethyl sulfoxide, may also be used. Particularly, methyl alcohol is preferred.

Catalyst: Initiators such as azonitrile initiators and organic peroxide initiators may be used.

Temperature: 20 to 90° C., preferably 40 to 70° C.

Time: 2 to 15 hours, preferably 3 to 11 hours.

Conversion: 10 to 90%, preferably 30 to 80% based on the amount of the vinyl acetate fed.

Content of resin in a solution after polymerization: 5 to 85%, preferably 20 to 70%.

In the process, the copolymerization may be performed in the presence of other copolymerizable components unless the object of the present invention is inhibited. The other components include olefin monomers such as propylene, 1-butene and isobutene; acrylamide-like monomers such as acrylamide, N-methylacrylamide, N-ethylacrylamide and N,N-dimethylacrylamide; methacrylamide-like monomers such as methacrylamide, N-methylmethacrylamide, N-ethyacrylamide and N,N-dimethylmethacrylamide; vinyl ether monomers such as methyl vinyl ether, ethyl vinyl ether, n-propyl vinyl ether, isopropyl vinyl ether, tert-butyl vinyl ether and dodecyl vinyl ether; allyl alcohol; vinyltrimetoxysilane; and N-vinyl-2-pyrrolidone.

After polymerization for a predetermined period of time to reach a predetermined conversion, at least one kind of conjugated polyene compound (C) is added and unreacted ethylene gas is removed by evaporation. Thereafter, unreacted vinyl acetate is expelled. From the viewpoint of uniform diffusion, the conjugated polyene compound (C) is preferably added after being dissolved in a solvent used for the polymerization. Similarly from the viewpoint of uniform diffusion, solution polymerization is preferred to bulk polymerization. The amount of the conjugated polyene compound (C) added is not particularly limited, but it is from about 0.0001 to 3% by weight, preferably from 0.0005 to 1% by weight, and even more preferably from 0.001 to 0.5% by weight when being indicated as the amount of the conjugated polyene compound (C) fed based on the amount of the vinyl acetate fed.

One example of the method of expelling unreacted vinyl acetate from the ethylene-vinyl acetate copolymer resulting from addition of a conjugated polyene compound (C) followed by removal of ethylene by evaporation is a method which comprises feeding a solution of the copolymer at a constant rate into a column filled with Raschig rings from an upper portion of the column, blowing a vapor of an organic solvent such as methanol into the column from its lower portion, distilling a mixed vapor of the organic solvent such as methanol and unreacted vinyl acetate from the column top, and collecting the copolymer solution from which unreacted vinyl acetate has been removed, from the column bottom.

An alkaline catalyst is added to the copolymer solution resulting from removal of unreacted vinyl acetate and the vinyl acetate component in the copolymer is saponified. The saponification may be effected either by continuous system or batch system. As the alkaline catalyst, sodium hydroxide, potassium hydroxide, alkali metal alcoholate, etc. are used.

The EVOH (A) after the saponification contains an alkaline catalyst, by-produced salts or other impurities. These are removed by washing, for example, with water. During this process, a certain amount of conjugated polyene compound (C) remains in the EVOH (A). Finally, drying is performed to obtain the EVOH (A) including the conjugated polyene compound (C).

To the thus-obtained EVOH (A) including the conjugated polyene compound (C), a phosphoric acid salt (B) is added to obtain a resin composition of the present invention. The incorporation method is not particularly restricted. For example, a method may be adopted in which the phosphoric acid salt (B) is mixed with a methanol paste including the EVOH and the conjugated polyene compound (C). In this process, an aqueous solution of the phosphoric acid salt (B) may be incorporated. A method in which a powder of the phosphoric acid salt (B) is melt-kneaded with the EVOH (A) including the conjugated polyene compound (C) is preferred from the productivity point of view.

For the melt-kneading, devices commonly used for melt-kneading of resin may be used. As a kneading device, a continuous kneading device such as a single screw extruder and a twin screw extruder may be used. Alternatively, a batch type kneading device such as a Banbury mixer may also be used. It is also permissible to mix a powder of the phosphoric acid salt (B), by use of a Henschel mixer or a tumbler, to pellets or a powder of an EVOH (A) including the conjugated polyene compound (C) before the feeding into such a kneading device.

The temperature during the melt-kneading is not particularly limited so long as EVOH (A) can be molten at that temperature, but it is preferably from 190 to 260° C. When the melt-kneading temperature is lower than 190° C., the EVOH (A) may be molten insufficiently. The melt-kneading temperature is more preferably 210° C. or higher. On the other hand, when the melt-kneading temperature is over 260° C., the EVOH (A) or phosphoric acid salt (B) may decompose. The melt-kneading temperature is more preferably 245° C. or lower.

The thus-obtained resin composition of the present invention has a characteristic that gas barrier properties are not diminished very much even after a treatment under high temperature, high humidity conditions like retort treatment.

In order to show such a characteristic effectively, it is also desirable that when a multilayer structure formed by sandwiching a layer of the resin composition having a thickness of 2 mils (51 μm) between polypropylene layers having a thickness of 9 mils (229 μm) is conducted to retort treatment at 121° C. for 60 minutes, in a differential scanning calorimetry (DSC) measurement of the layer of the resin composition after the retort treatment, the ratio (ΔH₂/ΔH₁) of the amount of heat absorbance (ΔH₂) of a second endothermic peak appearing between 80° C. and 135° C. to the amount of heat absorbance (ΔH₁) of a first endothermic peak corresponding to the melt of crystals of the EVOH (A) is 3 or more, and more preferably 5 or more.

The layer of the resin composition is sandwiched between polypropylene layers and the circumference thereof is also enclosed with polypropylene. Thus, the layer is configured not to be directly exposed to the atmosphere. Retorting is performed under condition including heating from room temperature to 121° C. over about 30 minutes, holding at 121° C. for 60 minutes, and then cooling to 100° C. or lower over about 30 minutes. When the sample cooled is taken out from the retorting apparatus and the polypropylene layers are peeled off rapidly, a layer of the resin composition is obtained. 5 mg of the layer of the resin composition is weighed out and used for DSC measurement. The time until the sample is sealed in a pan for DSC measurement is about 10 minutes from the time when the sample is taken out from the retorting apparatus.

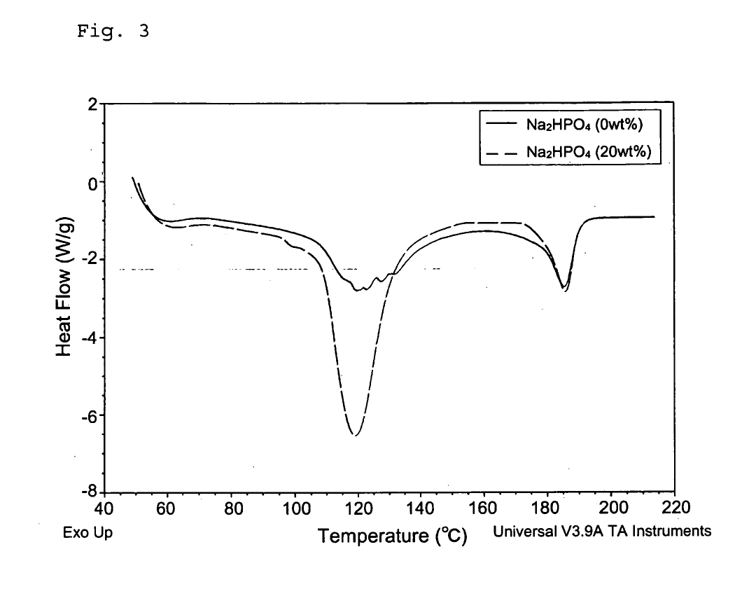

FIG. 3 shows a chart obtained by DSC measurement after treatment under the above-mentioned retort conditions for laminations like those mentioned above, one being prepared using a resin composition composed only of an EVOH (A) and a conjugated polyene compound (C) and the other being prepared using a resin composition further including a phosphoric acid salt (B). For both resin compositions, a first endothermic peak (the amount of heat absorption: ΔH₁) corresponding to the melt of crystals of EVOH (A) is observed near 186° C. Further, a second endothermic peak (the amount of heat absorbance: ΔH₂) is observed in the vicinity of from 115 to 120° C. For the resin composition not containing phosphoric acid salt (B), the ratio (ΔH₂/ΔH₁) of the amount of heat absorbance of the second endothermic peak to the amount of heat absorbance of the first endothermic peak is less than 3, whereas for the resin composition including the phosphoric acid salt (B), the ratio (ΔH₂/ΔH₁) is 3 or more.

The origin of the second endothermic peak is not clear, but it is conceivable to be a combination of an annealing effect by the heat applied in the retort treatment, the release of water from the phosphoric acid salt (B) forming a hydrate, the release of water from the EVOH (A) and the interaction between the EVOH (A) and the phosphoric acid salt (B). When the phosphoric acid salt (B) works effectively as a desiccant during the retort treatment, a large second endothermic peak is observed. It, therefore, is considered that an EVOH is kept in dry conditions immediately after the retort treatment and thus good gas barrier properties are shown. As a result, the sensitivity to humidity, which is a weak point of the EVOH (A), is greatly improved.

It is conceivable that the second endothermic peak appears through moist heat treatment at about 80 to 135° C., which is not restricted to retort treatment under the above-mentioned conditions. Also for such moist heat treatment, the effect of use of the resin composition of the present invention is expected. It, therefore, is expected that not only by a normal retort treatment conducted by heating to a temperature of 100° C. or higher and applying pressure in an autoclave but also by steam retorting, water cascade retorting, microwave retorting, hot filling, pasteurization, boiling, etc., similar phenomena will occur and similar effects are obtained.

The resin composition of the present invention preferably has a water content of not more than 1% by weight prior to melt-molding. By making the water content low, it is possible to inhibit the foaming during a melt molding process. The water content is more preferably not more than 0.5% by weight, and even more preferably not more than 0.25% by weight. In order to form a resin composition with such water content, a resin composition before melt-molding may be heated to dry or a resin composition may be prepared by using materials fully dried in advance.

The resin composition of the present invention may include other components unless the effects of the present invention are impaired. For example, it may include thermoplastic resin other than EVOH (A). Examples of such thermoplastic resin include polyolefins such as polyethylene (very low density, low density, middle density, high density), ethylene-vinyl acetate copolymers, ethylene-acrylic ester copolymers, polypropylene, ethylene-propylene copolymers and ionomers; products resulting from graft modification of such polyolefins with maleic anhydride, glycidyl methacrylate, etc.; semi-aromatic polyesters such as polyethylene terephthalate and polybutylene terephthalate; aliphatic polyesters such as polyvalerolactone, polycaprolactone, polyethylene succinate and polybutylene succinate; aliphatic polyamides such as polycaprolactam, polylaurolactam, polyhexamethylene adipamide, and polyhexamethylene azelamide; polyethers such as polyethylene glycol and polyphenylene ether.

Further, it may include various types of plasticizers, lubricants, stabilizers, surfactants, colorants, UV absorbers, antistatic agents, crosslinking agents, metal salts, fillers and reinforcements such as fibers.

The resin composition of the present invention is molded by melt molding into various molded articles such as films, sheets, containers, pipes and fibers. Available methods of melt molding include, for example, extrusion molding, inflation extrusion molding, blow molding, melt spinning, and injection molding. The melt molding temperature varies depending on the melting point of the EVOH (A), etc., but preferably is about 150 to 270° C.

The resin composition of the present invention may be used as a molded article consisting of a single layer of the resin composition only. The resin composition, however, is preferably fabricated into a multilayer structure including at least one layer thereof. When the resin composition of the present invention, an adhesive resin and a thermoplastic resin are abbreviated to EVOH, Tie and P, respectively, the layer constitution of the multilayer structure may be, but is not limited to, EVOH/P, P/EVOH/P, EVOH/Tie/P, and P/Tie/EVOH/Tie/P. Each of the layers shown above may be composed of either a single layer or, under certain circumstances, multiple layers.

In particular, in order to make use of one of the characteristics of the resin composition of the present invention as being excellent in moisture resistance, multilayer structures comprising a layer of the resin composition, and layers of at least one thermoplastic resin selected from the group consisting of polyolefin, polystyrene, polyester, polyamide, polyvinyl chloride, polyvinylidene chloride, polyvinyl acetate and polyacrylonitrile, arranged on both sides of the layer of the resin composition are preferred embodiments. Considering moisture resistance, polyolefin, polystyrene and polyester are preferably used and polyolefin is particularly preferably used.

Examples of the polyolefin include low density polyethylene, middle density polyethylene, high density polyethylene, linear low density polyethylene, ethylene-vinyl acetate copolymers, ethylene-propylene copolymers, polypropylene, polybutene, polymethylpentene and ionomers.

Multilayer structures are also preferred in which layers of at least one thermoplastic resin selected from the group consisting of polyolefin, polystyrene, polyester, polyamide, polyvinyl chloride, polyvinylidene chloride, polyvinyl acetate and polyacrylonitrile are arranged on both sides of the layer of the resin composition via an adhesive resin layer.

Although the adhesive resin is not particularly restricted so long as it can adhere the resin composition layer to the thermoplastic resin layers, an adhesive resin comprising carboxylic acid-modified polyolefin is preferred. The carboxylic acid-modified polyolefin referred to herein means a modified olefin-based polymer with a carboxyl group produced by linking an ethylenically unsaturated carboxylic acid or its anhydride to an olefin-based polymer chemically (for example, by addition reaction or graft reaction). The olefin-based polymer as used herein refers to polyolefin such as polyethylene (low pressure, middle pressure, high pressure), linear low density polyethylene, polypropylene and polybutene; and copolymers of an olefin and a comonomer copolymerizable with the olefin (e.g., vinyl ester and unsaturated carboxylic acid ester) such as ethylene-vinyl acetate copolymers and ethylene-ethyl acrylate copolymers. The ethylenically unsaturated carboxylic acid or its anhydride includes ethylenically unsaturated monocarboxylic acid, an ester thereof, ethylenically unsaturated dicarboxylic acid, and mono- or diester or anhydride thereof. Among them, ethylenically unsaturated dicarboxylic acid anhydride is preferred. Specific examples are maleic acid, fumaric acid, itaconic acid, maleic anhydride, itaconic anhydride, maleic acid monomethyl ester, maleic acid monoethyl ester, maleic acid diethyl ester and fumaric acid monomethyl ester. In particular, maleic anhydride is preferred.

The amount of the ethylenically unsaturated carboxylic acid or its anhydride added or grafted to the olefin-based polymer (modification degree) is 0.01 to 15% by weight and preferably 0.02 to 10% by weight based on the weight of the olefin-based polymer.

The thus-obtained coextruded multilayer structure or coinjected multilayer structure are subjected to secondary prosessing to obtain various types of molded articles, such as film, sheet, tube and bottle. Examples of such molded articles include:
(1) multilayer co-oriented sheets or films resulting from uniaxially or biaxially drawing of multilayer structures (e.g., sheet or film) followed, if necessary, by heat treatment;
(2) multilayer rolled sheets or films resulting from rolling of multilayer structures (e.g., sheets or films);
(3) multilayer tray cup-shaped containers resulting from thermoforming, e.g, vacuum forming, pressure forming and vacuum-pressure forming, of multilayer structures (e.g., sheets or films);
(4) bottle-shaped or cup-shaped containers resulting from stretch blow molding of multilayer structures (e.g., pipes); and
(5) bottle-shaped containers resulting from biaxially stretch blow molding of multilayer structures (e.g., parisons).

It is preferable for a thus-obtained multilayer structure that in a differential scanning calorimetry (DSC) measurement of the resin composition layer following retort treatment of the layer at 121° C. for 60 minutes, the ratio (ΔH₂/ΔH₁) of the amount of heat absorbance (ΔH₂) of a second endothermic peak appearing between 80 and 135° C. to the amount of heat absorbance (ΔH₁) of a first endothermic peak corresponding to the melt of crystals of the ethylene-vinyl alcohol copolymer (A) is 3 or more, and more preferably 5 or more.

Multilayer structures with such characteristics suffer from only a small loss in gas barrier properties even after treatment at high temperatures and high humidities like retort treatment. The method of DSC measurement, etc. has been described in the description on the resin composition.

In the multilayer structure of the present invention, it is desirable that the oxygen transmission rate after a lapse of 24 hours from retort treatment at 121° C. for 60 minutes is not more than 10 times as much as an oxygen transmission rate before the retort treatment. Normally, the gas barrier properties of a layer of EVOH are greatly diminished during retort treatment because a large amount of water comes to be contained in the EVOH. However, in the resin composition of the present invention containing phosphoric acid salt (B), deterioration of gas barrier properties is inhibited because the water coming into the resin composition during retort treatment is absorbed by the phosphoric acid salt (B). In addition, because the phosphoric acid salt (B) can absorb water remaining in the EVOH (A) matrix after the retort treatment, gas barrier properties recover quickly after the retort treatment and, therefore, it is possible to prevent contents from oxidation degradation effectively. The oxygen transmission rate after a lapse of 24 hours is more preferably 5 times or less, and even more preferably 3 times or less as much as an oxygen transmission rate before the retort treatment.

The oxygen transmission rate is a value measured according to ASTM F1307 and using an “Oxtran 2/21 Module H unit” manufactured by Mocon Inc. at 20° C. with internal and external relative humidities controlled to 100% and 65%, respectively.

The thus-obtained multilayer structure may be used for various applications without any limitations and it is suitably used as a material of wrapping film, deep drawn container, cup-shaped container, bottle, etc. In particular, it is suited for containers for packaging contents whose oxidation degradation should be avoided, especially foods. The multilayer structure of the present invention is particularly suited for containers for retort treatment because it exhibits good gas barrier properties even under high temperature and high humidity conditions. As the retort treatment, steam retorting, water cascade retorting, microwave retorting, etc. may be adopted as well as normal retorting by applying pressure under heating at a temperature of 100° C. or higher. The multilayer structure can be used not only for retorting. It is suited for containers for hot filling, pasteurization and boiling.

A recycled composition obtained by melt-kneading the multilayer structure is also a preferable embodiment of the present invention. In processes for producing thermoformed containers or the like, it is a usual practice to recover punch wastes or defective molded products generated during a process, pulverize them and reuse the resulting material for container production. Therefore, a multilayer structure having a layer of a recycled composition resulting from recycling and melt-kneading is a preferable embodiment from the economic point of view. The resin composition of the present invention is excellent in thermal stability even though it includes a phosphoric acid salt (B). Therefore, even a recycled composition which is to be melt-kneaded repeatedly is prevented from degradation effectively. A recycled composition layer is used for forming constitutions resulting from replacing the thermoplastic resin (P) layer(s) by are cycled composition (Reg) layer(s) or constitutions resulting from replacing the thermoplastic resin (P) layer(s) by a lamination(s) (P/Reg) composed of a thermoplastic resin (P) layer and a recycled composition (Reg) layer in the examples of the layer constitution of the multilayer structure described previously.

### EXAMPLES

The present invention is described below more concretely with reference to examples.

### Synthesis Example 1

Using a 100 L polymerization vessel which had a cooling coil inside and which was equipped with a four-blade paddle stirrer, continuous polymerization for producing an ethylene-vinyl acetate copolymer was performed. The polymerization conditions are as follows:
vinyl acetate feeding rate: 6.2 kg/hr
methanol feeding rate: 0.5 kg/hr
2,2′-azobis-(2,4-dimethylvaleronitrile) feeding rate as 2.8 g/L methanol solution: 0.3 L/hr
polymerization temperature: 60° C.
ethylene pressure in polymerization vessel: 35 kg/cm²
mean residence time: 7 hours

As the result, a polymerization solution with a polymerization ratio of vinyl acetate of about 40% was discharged from the polymerization vessel at a rate of 7 kg/hr. In the polymerization solution, the concentration of ethylene-vinyl acetate copolymer (ethylene content: 27 mol %) was about 40% by weight.

Immediately after the discharge from the polymerization vessel, a 1.0 g/L β-myrcene solution in methyl acetate was added and mixed at a rate of 2.0 L/hr to the polymerization solution. After the mixing, the mixture was introduced to a plate column. Methanol vapor was blown from the bottom at a rate of 3.5 kg/hr. Thus, unreacted vinyl acetate and ethylene were separated from the top and a 40% by weight ethylene-vinyl acetate copolymer solution in methanol was obtained at a rate of 7 kg/hr.

A methanol solution prepared by adding 1 part by weight of sodium hydroxide to 100 parts by weight of the copolymer solution was subjected to saponification for 30 minutes under blowing of methanol vapor at 110° C. and 3.5 kg/cm². The methyl acetate formed during the reaction was removed out of the system by distillation together with part of the methanol. To the resulting saponificated solution, a water-methanol vapor was further blown. Thus, a methanol-water mixed vapor was distilled off and a saponificated solution in a methanol-water mixed solvent (methanol/water=65/35, weight ratio) with a saponificated copolymer concentration of 35% by weight was obtained. This solution was discharged through a die with a hole 2 mm in diameter into a water-methanol mixed solution (methanol content: 10% by weight) at 5° C. to be coagulated in a strand form. The strand was cut with a cutter into pellets with lengths ranging from 2.5 to 3.5 mm. Thereafter, the pellets were washed with process water of an amount of 15 parts by weight for 1 part by weight of the pellets, followed by draining and drying. Thus, a saponified ethylene-vinyl acetate copolymer with a saponification degree of 99.3 mol % and a melt flow rate of 3.8 g/10 min was obtained. The content of β-myrcene was 0.05% by weight.

### Synthesis Examples 2 to 9

EVOHs (A) containing conjugated polyene compounds were prepared in manners similar to that of Synthesis Example 1 using a methanol solution of sorbic acid (Synthesis Example 2), a methyl acetate solution of α-farnesene (Synthesis Example 3), a methyl acetate solution of 2,4-diphenyl-4-methyl-1-pentene (Synthesis Example 4), a methanol solution of eleostearic acid (Synthesis Example 5), a methyl acetate solution of isoprene (Synthesis Example 7), a methyl acetate solution of 1,3-butadiene (Synthesis Example 8), and a methyl acetate solution of styrene (Synthesis Example 9) in place of the methyl acetate solution of β-myrcene of Synthesis Example 1 so that those polyene compounds were added in the same molar amount as that of the β-myrcene in Synthesis Example 1. Further, an EVOH (A) was prepared similarly by using a ⅓ molar amount of a methanol solution of tung oil (Synthesis Example 6). In Synthesis Example 6, tung oil was added in an amount ⅓ the molar amounts of the other polyene compounds in the other Synthesis Examples in consideration of the fact that three trienes are contained in one tung oil molecule. The ethylene contents, saponification degrees and melt flow rates of the resulting EVOHs (A) were almost the same as those of Synthesis Example 1. The boiling points and content of conjugated polyene compounds are summarized in Table 1.

### Synthesis Example 10

An EVOH (A) was prepared in a manner similar to Synthesis Example 1 adding no additives substituting for β-myrcene. The ethylene content, saponification degree and melt flow rate of the resulting EVOH were almost the same as those of Synthesis Example 1.

### Synthesis Example 11

An EVOH (A) containing β-myrcene was prepared in a manner similar to Synthesis Example 1 except adjusting the ethylene pressure to 45 kg/cm². The resulting EVOH (A) had an ethylene content of 32 mol %, a saponification degree of 99.5 mol %, and a melt flow rate of 1.6 g/10 min. The content of β-myrcene was 0.05% by weight.

TABLE 1

| | | | | Polyene |
|---|---|---|---|---|
| | Ethylene | | | compound |
| | content | | Boiling | content |
| | (mol %) | Polyene compound | point (° C.) | (wt %) |
| Synthesis | 27 | β-Myrcene | 167 | 0.05 |
| Example 1 | | | | |
| Synthesis | 27 | Sorbic acid | 228 | 0.002 |
| Example 2 | | | | |
| Synthesis | 27 | α-Farnesene | 260 | 0.09 |
| Example 3 | | | | |
| Synthesis | 27 | 2,4-Diphenyl-4- | 310 | 0.07 |
| Example 4 | | methyl-1-pentene | | |
| Synthesis | 27 | Eleostearic acid | >300 | 0.005 |
| Example 5 | | | | |
| Synthesis | 27 | Tung oil | >300 | 0.008 |
| Example 6 | | | | |
| Synthesis | 27 | Isoprene | 34 | Not |
| Example 7 | | | | measured |
| Synthesis | 27 | 1,3-Butadiene | −5 | Not |
| Example 8 | | | | measured |
| Synthesis | 27 | Styrene | 143 | 0.03 |
| Example 9 | | | | |
| Synthesis | 27 | None | — | — |
| Example 10 | | | | |
| Synthesis | 32 | β-Myrcene | 167 | 0.05 |
| Example 11 | | | | |

### Example 1

### Evaluation of Desiccants

Into 80 parts by weight of the EVOH obtained in Synthesis Example 11, which contained 0.05% by weight of β-myrcene and had an ethylene content of 32 mol %, 20 parts by weight of each of the compounds given in Table 2 was separately incorporated and melt-kneaded in a twin screw extruder at 230° C. to obtain resin composition pellets. The compounds incorporated into the EVOH are anhydrides. Using the resin composition pellets, adhesive resin (Tie) pellets of an adhesive resin (maleic anhydride-modified polypropylene) “ADMER QF551A” manufactured by Mitsui Chemicals, Inc., and polypropylene (PP) pellets, multilayer sheets having a structure “PP/Tie/EVOH composition/Tie/PP” with thicknesses 24(610)/2(51)/4(102)/2(51)/24(610) mil (μm) were produced by a three-kind, five-layer sheet forming machine. Cups with a capacity of 300 cc were obtained by thermoforming the resulting multilayer sheets. For the cups obtained, the oxygen transmission rate was measured according to ASTM F1307 and using an “Oxtran 2/21 Module H unit” manufactured by Mocon Inc. at 20° C. with internal and external relative humidities controlled to 100% and 65%, respectively. Subsequently, using an autoclave “HV-50” manufactured by Hirayama Manufacturing Corp., the cups were heated from room temperature to 121° C. over about 30 minutes, held at 121° C. for 30, 60 or 90 minutes, and then cooled to 100° C. or lower over about 30 minutes. The cups were thereafter left to stand in an atmosphere at 20° C. and a relative humidity of 65% for 24 hours and then measured for an oxygen transmission rate in the same manner as before retort treatment. The results are summarized in Table 2.

TABLE 2

| | Oxygen transmission rate after | | | |
|---|---|---|---|---|
| | retorting (10⁻² cc/pkg · day · atm) | | | |
| | Retort condition | | | |
| Desiccant | No Retort | 30 min | 60 min | 90 min |
| None | 0.3 | 2.3 | 3.6 | 10.3 |
| Sodium dihydrogenphosphate | 0.29 | 0.6 | 0.7 | 1.2 |
| Disodium hydrogenphosphate | 0.3 | 0.4 | 0.4 | 1.1 |
| Sodium phosphate | 0.28 | 0.4 | 0.5 | 0.6 |
| Sodium pyrophosphate | 0.21 | 0.3 | 0.8 | 2.3 |
| Lithium phosphate | 0.2 | 0.3 | 0.5 | 0.8 |
| Sodium borate | 0.27 | 0.5 | 1.8 | 7.9 |
| Sodium sulfate | 0.33 | 0.7 | 1.9 | 13.4 |
| Sodium nitrate | 0.37 | 0.6 | 7.8 | 9.4 |
| Sodium chloride | 0.54 | 0.7 | 5.5 | 13.9 |
| Sugar | 0.35 | 0.9 | 7.1 | 28.1 |

As is clear from Table 2, when a phosphoric acid salt (B) is incorporated into an EVOH (A), the gas barrier properties after retort treatment is greatly improved in comparison to a case where no phosphoric acid salt is incorporated. Further, it is also clear that phosphoric acid salts (B) are effective over other salts or sugars.

### Example 2

### Effects of Impurities in Phosphoric Acid Salts

For three production lots (Lot A, Lot B and Lot C) of anhydrous disodium hydrogenphosphate (Na₂HPO₄) “683522” manufactured by ICL, the impurity specifications provided by ICL, pH of 1-% by weigh aqueous solutions and results of thermogravimetric analysis are summarized in Table 3. The thermogravimetric analysis was conducted by increasing the temperature from room temperature to 600° C. at a rate of 20° C./min using “TGA Q500” manufactured by TA Instruments. The weight loss onset temperature and the weight loss end temperature are values automatically calculated by the analyzer.

Into the EVOH obtained in Synthesis Example 1, which contained 0.05% by weight of β-myrcene and had an ethylene content of 27 mol %, the three kinds of anhydrous disodium hydrogenphosphate were separately incorporated so that the contents of the salts became to 15% by weight. After melt-kneading with a twin screw extruder at 230° C., resin composition pellets were obtained. For the three kinds of resin composition pellets obtained, the yellowness index, melt flow rate (at 210° C. under a load of 2160 g), ash content, odor and appearance were evaluated. The base EVOH (A) had a melt flow rate (at 210° C. under a load of 2160 g) of 3.8 g/10 min and a yellowness index of 18. The ash content was determined on the basis of weight loss after combusting the samples in a muffled furnace for 20 minutes at 600° C. The evaluation results are summarized in Table 3.

TABLE 3

| Characteristics | | | Lot A | Lot B | Lot C |
|---|---|---|---|---|---|
| Phosphate | Purity (wt %) | | 99.8 | 99.9 | 99.8 |
| | Pyrophsphate (wt %) | | 0.68 | 0.72 | 0.49 |
| | Lead (ppm) | | 2.5 | 2.9 | 2.1 |
| | Fluoride (ppm) | | 21 | 33 | 17 |
| | pH of 1-wt % aqueous | | 9.19 | 9.31 | 8.80 |
| | solution | | | | |
| | TGA | Weight loss onset | 275.0 | 269.8 | 224.2 |
| | | temperature (° C.) | | | |
| | | Weight loss end | 309.5 | 310.2 | 271.7 |
| | | temperature (° C.) | | | |
| | | Weight loss ratio | 6.527 | 6.912 | 6.264 |
| | | (wt %) | | | |

| | | | | |
|---|---|---|---|---|
| Resin | Yellowness index | 21 | 18 | 45 |
| composition | Melt flow rate | 3.4 | 3.4 | 3.0 |
| | (g/10 min) | | | |
| | Ash content (wt %) | 13.9 | 13.5 | 14.6 |
| | Aldehyde smell | None | None - weak | Strong |
| | Pellet appearance | Good | Good | Porous |

Table 3 shows that Lot C, which had a low pH and a low weight loss onset temperature measured by thermogravimetric analysis, problematically suffered from coloring, odor generation and foaming. In other words, even among phosphoric acid salts (B) commercially available under the same brand, only products of specified production lots can be used suitably for the purpose of the present invention.

### Example 3

### Particle Size of Phosphoric Acid Salt (B)

Into 80 parts by weight of the EVOH obtained in Synthesis Example 11, which contained 0.05% by weight of β-myrcene and had an ethylene content of 32 mol %, 20 parts by weight of each of anhydrous disodium hydrogenphosphate (Na₂HPO₄) which had a particle size distribution shown in Table 4 was separately incorporated and melt-kneaded in a twin screw extruder at 230° C. to obtain resin composition pellets. The anhydrous disodium hydrogenphosphates having the particle size distributions are products obtained by grinding anhydrous disodium hydrogenphosphate “683522” manufactured by ICL using a fluidized bed jet mill “Hosokawa AFG-100” manufactured by Alpine and Hosokawa Micro Powder Systems. The jet mill is a machine in which particles are ground through their collision caused by collision of opposing jet air flows. The jet mill has a multi-wheel classifier therein. By varying the rotation speed of the multi-wheel classifier, it is possible to obtain particles with a desired particle size.

Using the pellets of the resulting resin compositions, cups with a capacity of 300 cc were produced in the same manner as Example 1. The side wall was 28.2 μm in thickness. Each of the cups obtained was heated from room temperature to 121° C. over about 30 minutes, held at 121° C. for 60 minutes, and then cooled to 100° C. or lower over about 30 minutes using an autoclave “HV-50” manufactured by Hirayama Manufacturing Corp. Then, the oxygen transmission rate was measured in the same manner as Example 1 in an atmosphere at 20° C. and a relative humidity of 65%. The results are summarized in Table 4.

TABLE 4

| | | | | | | Oxygen |
|---|---|---|---|---|---|---|
| Rotation | Particle diameter (μm) | | | | | transmission rate |
| speed (rpm) | Average | D50 | D90 | D97 | D100 | (cc/pkg · day · atm) |
| Before | 16.3 | 13.6 | 34.9 | 59.1 | 113 | >13 |
| grinding | | | | | | |
| 1000 | 12.3 | 9.6 | 29.2 | 43.5 | 58 | 2.38 |
| 2000 | 6.6 | 4.4 | 16.0 | 27.6 | 33 | 1.44 |
| 2500 | 5.0 | 2.6 | 13.0 | 15.2 | 27 | 0.37 |
| 3000 | 2.2 | 1.4 | 5.3 | 10.9 | 13 | 0.43 |

Table 4 shows that the smaller the particle size, the better the gas barrier properties after retort treatment. In other words, multilayer structures with better gas barrier properties at high temperatures and high humidities can be obtained by using commercially available phosphoric acid salt (B) after finely dividing rather than by using it as received. In particular, it seems important that there are, if any, few coarse particles larger than the thickness of the resin composition layer.

### Example 4

### Incorporation Amount of Phosphoric Acid Salt (B)

Into the EVOH obtained in Synthesis Example 11, which contained 0.05% by weight of β-myrcene and had an ethylene content of 32 mol %, an anhydrous sodium dihydrogenphosphate (NaH₂PO₄) “N11-30” manufactured by Gallard-Budenheim was incorporated so that the content shown in Table 5 was achieved, and melt-kneaded in a twin screw extruder at 230° C. to obtain resin composition pellets. Using the resulting resin composition pellets, a cup with a capacity of 300 cc was produced in the same manner as Example 1. For the cup obtained, the oxygen transmission rates before and after retort treatment were measured in the same manner as Example 1. The results are summarized in Table 5.

TABLE 5

| Phosphoric | Oxygen transmission rate after retort | | | |
|---|---|---|---|---|
| acid | treatment (10⁻² cc/pkg · day · atm) | | | |
| salt content | Retort treatment condition | | | |
| (wt %) | No Retort | 30 min | 60 min | 90 min |
| 0% | 0.28 | 2.3 | 3.7 | 12.5 |
| 5% | 0.32 | 1.4 | 3.2 | 9.6 |
| 10% | 0.33 | 0.9 | 2.1 | 4.7 |
| 20% | 0.3 | 0.35 | 0.5 | 0.8 |
| 30% | 0.31 | 0.37 | 0.34 | 0.48 |

Table 5 shows that incorporation of anhydrous sodium dihydrogenphosphate into the EVOH (A) greatly improved gas barrier properties after retort treatment in comparison to the cases without incorporation of the salt. Further, it is also shown that as the amount of the anhydrous sodium dihydrogenphosphate incorporated is increased, gas barrier properties can be maintained after a longer retort treatment.

### Example 5

### Long-Term Change of Oxygen Transmission Rate After Retorting

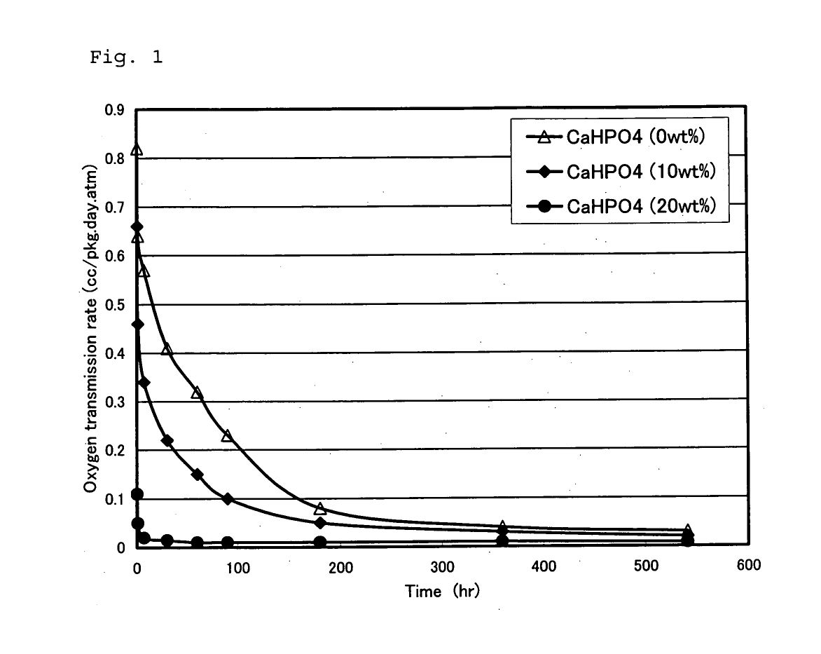

Into the EVOH obtained in Synthesis Example 1, which contained 0.05% by weight of β-myrcene and had an ethylene content of 27 mol %, an anhydrous calcium hydrogenphosphate (CaHPO₄) “C12-03” manufactured by Gallard-Budenheim was incorporated in an amount of 10 or 20 parts by weight based on 100 parts by weight of the total amounts of the EVOH and the anhydrous calcium hydrogenphosphate, and melt-kneaded in a twin screw extruder at 230° C. to obtain resin composition pellets. Using the resin composition pellets or raw material EVOH, multilayer sheets having a structure “PP/Tie/EVOH composition/Tie/PP” with thicknesses 30(762)/1(25)/3(76)/1(25)/30(762) mil (μm) were produced by a three-kind, five-layer sheet forming machine in a manner like Example 1. Using the resulting multilayer sheets, trays with a capacity of 200 cc and a drawing depth of 1.5 inch (38 mm) were produced by thermoforming. Each of the resulting trays was subsequently heated from room temperature to 121° C. over about 30 minutes, held at 121° C. for 60 minutes, and then cooled to 100° C. or lower over about 30 minutes using an autoclave “HV-50” manufactured by Hirayama Manufacturing Corp. For each sample, the oxygen transmission rate before retort treatment and that after a lapse of a predetermined time after retort treatment were measured. The results are shown in FIG. 1. FIG. 1 is a graph showing the change of oxygen transmission rate with time after retort treatment.

FIG. 1 shows that when no anhydrous calcium hydrogenphosphate is contained, gas barrier properties are recovered slowly over ten or more days. In other words, it is shown that it is difficult to use a resin composition not containing anhydrous calcium hydrogenphosphate for applications where prevention of oxidization degradation is strictly required because of continuation of a very long period of time in which gas barrier properties are kept low. In contrast, when 20% by weight of anhydrous calcium hydrogenphosphate was contained, the oxygen transmission rate decreased to 0.05 cc/pkg.day.atm only within one hour. It, therefore, can be understood that gas barrier properties are expected to recover rapidly.

### Example 6

### Influence of Water Absorption

Into the EVOH obtained in Synthesis Example 1, which contained 0.05% by weight of β-myrcene and had an ethylene content of 27 mol %, an anhydrous disodium hydrogenphosphate “683522” manufactured by ICL was incorporated in an amount of 10 or 20 parts by weight based on 100 parts by weight of the total amounts of the EVOH and the anhydrous disodium hydrogenphosphate, and melt-kneaded in a twin screw extruder at 230° C. to obtain resin composition pellets. By supplying the resulting pellets or a raw material EVOH to an extruder (“Labo Plastomill 20R200” manufactured by Toyo Seiki Seisaku-Sho, Ltd.) equipped with a film attachment, monolayer films with predetermined thicknesses were produced and then the films were cut into a size of 6 inch (152 mm) by 6 inch (152 mm). Further, polypropylene films having a certain thickness and a size of 8 inch (203 mm) by 8 inch (203 mm) were prepared. A resin composition was sandwiched between polypropylene films and pressed between hot plates at 196° C. to obtain a three-layer sheet. Because the polypropylene films had larger areas, the resin composition film was sealed completely in the polypropylene.

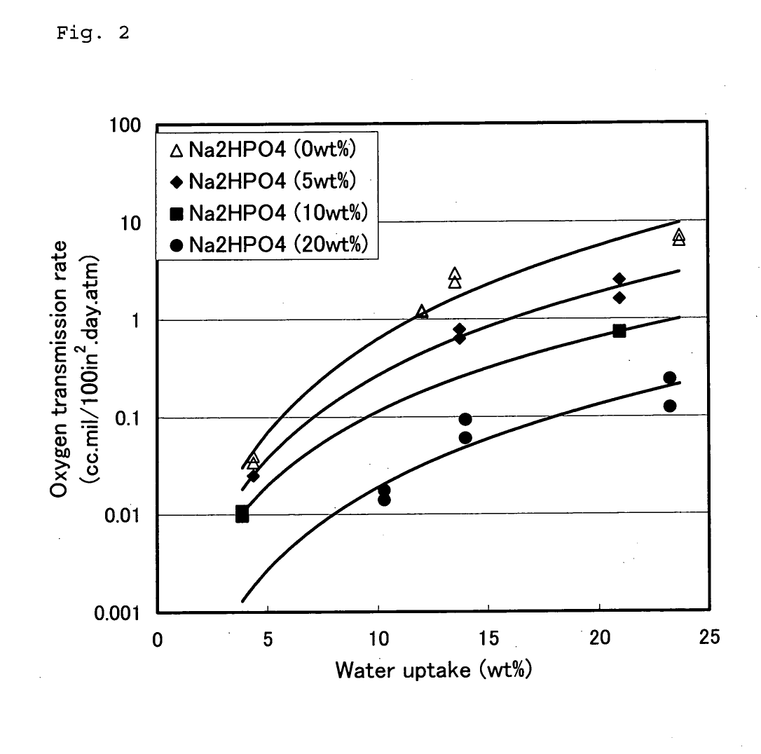

Nine types of multilayer sheet samples with the layer constitutions shown in Table 6 were prepared and subjected to retort treatment at 121° C. for predetermined periods of time. Three sheets were retort treated at a time under the same test conditions. They were heated from room temperature to 121° C. over about 30 minutes, held at 121° C. for predetermined periods of time, and then cooled to 100° C. or lower over about 30 minutes using an autoclave “HV-50” manufactured by Hirayama Manufacturing Corp. The cooled samples were taken out from the retorting apparatus. Thereafter, from one of the sheets, the resin composition layer was rapidly taken by peeling the polypropylene layers away and the water content (% by weight) was measured. The time until the sample was subjected to the measurement was about 10 minutes from the time when the sample was taken out from the retorting apparatus. For the two remaining sheets, the oxygen transmission rate (cc/pkg.day.atm) was measured in the same manner as Example 1. The results are shown in FIG. 2. FIG. 2 is a graph showing the dependency of oxygen transmission rate on water uptake.

TABLE 6

| PP/EVOH/PP layer | Na₂HPO₄ content | |
|---|---|---|
| thickness (mil) | (wt %) | Retort time (min) |
| 7.5/1/7.5 | 0 | 12 |
| 7.5/1/7.5 | 20 | 12 |
| 9/2/9 | 0 | 20 |
| 9/2/9 | 20 | 20 |
| 9/2/9 | 0 | 60 |
| 9/2/9 | 10 | 60 |
| 9/2/9 | 20 | 60 |
| 19/2/19 | 0 | 60 |
| 19/2/19 | 20 | 60 |

FIG. 2 shows that regardless of the presence of anhydrous disodium hydrogenphosphate, the oxygen transmission rate tends to increase as the water uptake increases. However, the oxygen transmission rate decreases as the amount of anhydrous disodium hydrogenphosphate increases, even though the water content is the same. In other words, when the amount of anhydrous disodium hydrogephosphate is larger, better gas barrier properties are exerted even if much water is taken in.

### Example 7

### DSC Measurement

Into the EVOH obtained in Synthesis Example 1, which contained 0.05% by weight of β-myrcene and had an ethylene content of 27 mol %, an anhydrous disodium hydrogenphosphate (Na₂HPO₄) “683522” manufactured by ICL was incorporated in an amount of 20 parts by weight based on 100 parts by weight of the total amounts of the EVOH and the anhydrous disodium hydrogenphosphate, and melt-kneaded in a twin screw extruder at 230° C. to obtain resin composition pellets. For the resin composition in which anhydrous disodium hydrogenphosphate had been incorporated and an EVOH with no incorporation of the salt, monolayer films with a thickness of 1 mil (25 μm) were prepared in the same manner as Example 6, which were cut into 6 inch (152 mm)×6 inch (152 mm). Further, polypropylene films having a thickness of 9 mil (229 μm) and a size of 8 inch (203 mm) by 8 inch (203 mm) were prepared. In the same manner as Example 6, the resin composition film was sandwiched between the polypropylene films and pressed to obtain a three-layer sheet. The resin composition film was sealed completely in the polypropylene.

The thus-obtained multilayer sheets were heated from room temperature to 105° C., 121° C. or 132° C. over about 30 minutes, held at the temperature for 30 or 60 minutes, and then cooled to 100° C. or lower over about 30 minutes using an autoclave “HV-50” manufactured by Hirayama Manufacturing Corp. When each of the sample cooled was taken out from the retorting apparatus and the polypropylene layers are peeled off rapidly, 5 mg of the resin composition layer was weighed out and used for DSC measurement. The time until a sample was sealed in a pan for DSC measurement was about 10 minutes from the time when the sample was taken out from the retorting apparatus.

The DSC was measured at a ramp rate of 20° C./min using a “DSC2910” manufactured by TA Instruments Ltd. FIG. 3 is a DSC chart measured when retort treatment was conducted at 121° C. for 60 minutes. For every sample, the first endothermic peak (the amount of heat absorption: ΔH₁) corresponding to the melt of stals of an EVOH (A) and the second endothermic peak (the unt of heat absorption: ΔH₂) in the vicinity of from 115 to 120° C. are shown together in Table 7.

TABLE 7

| | 7 mol % Et. EVOH + 0 wt % disodium | | | | | 27 mol % Et. EVOH + 20 wt % disodium | | | | |
|---|---|---|---|---|---|---|---|---|---|---|
| | hydrogenphosphate | | | | | hydrogenphosphate | | | | |
| | First endothermic | | Second | | | First | | Second | | |
| | peak | | endothermic peak | | | endothermic peak | | endothermic peak | | |
| Retort | Temperature | ΔH₁ | Temperature | ΔH₂ | ΔH₁/ | Temperature | ΔH₁ | Temperature | ΔH₂ | ΔH₁/ |
| conditions | (° C.) | (J/g) | (° C.) | (J/g) | ΔH₂ | (° C.) | (J/g) | (° C.) | (J/g) | ΔH₂ |
| No | 187.0 | 88.3 | 88.3 | 9.3 | 0.1 | 186.5 | 70.3 | 103.4 | 8.7 | 0.1 |
| treatment | | | | | | | | | | |
| 105° C., | 186.8 | 56.5 | 119.8 | 50.2 | 0.9 | 186.5 | 53 | 116.5 | 76.1 | 1.4 |
| 60 min | | | | | | | | | | |
| 121° C., | 186.8 | 56.5 | 119.8 | 50.2 | 0.9 | 186.4 | 44.3 | 117.1 | 210 | 4.7 |
| 30 min | | | | | | | | | | |
| 121° C., | 185.5 | 52.1 | 116 | 113.1 | 2.2 | 186.1 | 41.2 | 119.5 | 323.9 | 7.9 |
| 60 min | | | | | | | | | | |
| 132° C., | 186.8 | 62.1 | 117 | 97.4 | 1.6 | 185.1 | 35.7 | 117.5 | 415.7 | 11.6 |
| 60 min | | | | | | | | | | |

As it is clear from Tables 3 and 7, incorporation of anhydrous disodium hydrogenphosphate makes the second endothermic peak larger. Particularly, this tendency becomes more noticeable as the retort temperature becomes higher or the retort time becomes longer.

### Example 8

### Thermal Stability

Into each of the EVOHs obtained in Synthesis Examples 1 to 10, which contained various polyene compounds and had an ethylene content of 27 mol %, an anhydrous calcium hydrogenphosphate (CaHPO₄) “C12-03” manufactured by Budemheim-Gallard was incorporated in an amount of 20 parts by weight based on 100 parts by weight of the EVOH and the anhydrous calcium hydrogenphosphate, and melt-kneaded in a twin screw extruder at 230° C. to obtain resin composition pellets.

Using the resulting pellets, monolayer films with a thickness of 2 mil (51 μm) were produced by an extruder (“Labo Plastomill 20R200” manufactured by Toyo Seiki Seisaku-Sho, Ltd.) equipped with a film attachment. The extruder was equipped with a screw with an L/D ratio of 24 and a compression ratio of 3.2 and also was equipped with a coat hanger style, 8 inch (203 mm) wide die. The temperature profile for the extruder barrel zones 1, 2 and 3 was 175° C., 215° C. and 225° C., respectively. The temperature of the die was set to 200° C. Results of counting the number of gels per 100 cm² of the resulting monolayer films are shown in Table 8 (with anhydrous dicalcium hydrogenphosphate) and Table 9 (without anhydrous dicalcium hydrogenphosphate).

As model compositions of recycled resin compositions used were resin compositions obtained by mixing polypropylene “P4G2Z-159” manufactured by Huntsman Polymers, adhesive resin (maleic anhydride-modified polypropylene) “Admer QF551A” manufactured by Mitsui Chemicals, Inc. and pellets of the above-mentioned resin composition composed of EVOH and anhydrous calcium hydrogenphosphate, and a heat stabilizer “GF-30” manufactured by EVAL Company of America so that their contents became 78% by weight, 10% by weight, 10% by weight and 2% by weight, respectively. Using an extruder (“Labo Plastomill 20R200” manufactured by Toyo Seiki Seisaku-Sho, Ltd.) equipped with a three-hole strand die, the resin composition was passed through the extruder repeatedly seven times. Then, monolayer films with a thickness of 2 mil (51 μm) were produced by an extruder (“Labo Plastomill 20R200” manufactured by Toyo Seiki Seisaku-Sho, Ltd.) equipped with a film attachment. Results of counting the number of black spots per 100 cm² of the resulting monolayer films are shown in Table 8 (without anhydrous calcium hydrogenphosphate) and Table 9 (with anhydrous calcium hydrogenphosphate). Black spots are probably deterioration products formed during a long-period kneading operation.

TABLE 8

| | | | | | | The number of black |
|---|---|---|---|---|---|---|
| | Phosphoric | Boiling | Residual | | The number of | spots in a recyclred |
| | acid salt | point | polyene | | gels in a film | composition film |
| Polyene compound | content (%) | (° C.) | (wt %) | YI | (gels/100 cm²) | (spots/100 cm²) |
| β-Myrcene | 0 | 167 | 0.05 | 19 | 9 | 3 |
| Sorbic acid | 0 | 228 | 0.002 | 24 | 3 | 3 |
| α-Farnesene | 0 | 260 | 0.09 | 20 | 5 | 2 |
| 2,4-Diphenyl-4-methyl- | 0 | 310 | 0.07 | 17 | 8 | 2 |
| 1-pentene | | | | | | |
| Eleostearic acid | 0 | >300 | 0.005 | 15 | 6 | 1 |
| Tung oil | 0 | >300 | 0.008 | 22 | 3 | 1 |
| Isoprene | 0 | 34 | Not | 55 | 15 | 11 |
| | | | measured | | | |
| 1,3-Butadiene | 0 | −5 | Not | 46 | 9 | 22 |
| | | | measured | | | |
| Styrene | 0 | 143 | 0.03 | 39 | 41 | 13 |
| None | 0 | — | — | 30 | 75 | 39 |

TABLE 9

| | | | | | | The number of black |
|---|---|---|---|---|---|---|
| | Phosphoric | Boiling | Residual | | The number of | spots in a recycled |
| | acid salt | point | polyene | | gels in a film | composition film |
| Polyene compound | content (%) | (° C.) | (wt %) | YI | (gels/100 cm²) | (spots/100 cm²) |
| β-Myrcene | 20 | 167 | 0.04 | 15 | 10 | 4 |
| Sorbic acid | 20 | 228 | 0.002 | 16 | 4 | 6 |
| α-Farnesene | 20 | 260 | 0.07 | 22 | 6 | 2 |
| 2,4-Diphenyl-4-methyl- | 20 | 310 | 0.06 | 14 | 6 | 5 |
| 1-pentene | | | | | | |
| Eleostearic acid | 20 | >300 | 0.004 | 24 | 5 | 1 |
| Tung oil | 20 | >300 | 0.007 | 25 | 11 | 2 |
| Isoprene | 20 | 34 | Not | 53 | 16 | 28 |
| | | | measured | | | |
| 1,3-Butadiene | 20 | −5 | Not | 35 | 111 | 57 |
| | | | measured | | | |
| Styrene | 20 | 143 | 0.02 | 32 | 76 | 35 |
| None | 20 | — | — | 35 | 255 | 112 |

As it is understood from the comparison of the Examples without addition of polyene compounds shown in Tables 8 and 9, incorporation of phosphoric acid salt (B) into EVOH (a) greatly diminishes the thermal stability of resulting resin compositions and results in remarkable increase in coloring, gel formation and black spots in recycled resin compositions. Further, in the case of using polyene compounds with a boiling point below 150° C., incorporation of no phosphoric acid salt (B) leads to a noticeable effect on improving the thermal stability as shown in Table 8, but incorporation of phosphoric acid salt (B) results in a quite unsatisfactory effect on improving the thermal stability of EVOH (A) as shown in Table 9. In contrast, in the case of using polyene compounds with a boiling point of 150° C. or higher, it is found that a remarkable effect on improving the thermal stability is exhibited even for an EVOH (A) containing a phosphoric acid salt (B).

What is claimed is:

1. A resin composition comprising: an ethylene-vinyl alcohol copolymer (A) having an ethylene content of from 15 to 65 mol % and a saponification degree of at least 95 mol %, a phosphoric acid salt (B) which can form a hydrate, and a conjugated polyene compound (C) having a boiling point of at least 150° C., wherein the resin composition comprises from 50 to 99 parts by weight of (A), from 1 to 50 parts by weight of (B) and from 0.00001 to 1 parts by weight of (C), based on 100 parts by weight of the total amounts of (A) and (B).

2. The resin composition according to claim 1, wherein the phosphoric acid salt (B) comprises a powder containing 97% by volume or more of particles having a particle diameter of 16 μm or less.

3. The resin composition according to claim 1, wherein a weight loss onset temperature of the phosphoric acid salt (B) measured by thermogravimetric analysis is at least 245° C.

4. The resin composition according to claim 1, wherein when a multilayer structure formed by sandwiching a layer of the resin composition having a thickness of 2 mils between polypropylene layers having a thickness of 9 mils is conducted to retort treatment at 121° C. for 60 minutes, in a differential scanning calorimetry (DSC) measurement of the layer of the resin composition after the retort treatment, the ratio (ΔH₂/ΔH₁) of the amount of heat absorbance (ΔH₂) of a second endothermic peak appearing between 80° C. and 135° C. to the amount of heat absorbance (ΔH₁) of a first endothermic peak corresponding to the melt of crystals of the ethylene-vinyl alcohol copolymer (A) is 3 or more.

5. A multilayer structure comprising a layer of the resin composition according to claim 1, and layers of at least one thermoplastic resin selected from the group consisting of polyolefins, polystyrenes, polyesters, polyamides, polyvinyl chlorides, polyvinylidene chlorides, polyvinyl acetates and polyacrylonitriles, arranged on both sides of the layer of the resin composition.

6. The multilayer structure according to claim 5, wherein the layers of a thermoplastic resin selected from the group consisting of polyolefins, polystyrenes, polyesters, polyamides, polyvinyl chlorides, polyvinylidene chlorides, polyvinyl acetates and polyacrylonitriles are arranged on both sides of the layer of the resin composition via an adhesive resin layer.

7. The multilayer structure according to claim 5, wherein in a differential scanning calorimetry (DSC) measurement of the resin composition layer following retort treatment of the layer at 121° C. for 60 minutes, the ratio (ΔH₂/ΔH₁) of the amount of heat absorbance (ΔH₂) of a second endothermic peak appearing between 80 and 135° C. to the amount of heat absorbance (ΔH₁) of a first endothermic peak corresponding to the melt of crystals of the ethylene-vinyl alcohol copolymer (A) is 3 or more.

8. The multilayer structure according to claim 5, wherein an oxygen transmission rate after a lapse of 24 hours from retort treatment at 121° C. for 60 minutes is not more than 10 times as much as an oxygen transmission rate before the retort treatment.

9. A recycled resin composition prepared by melt-kneading the multilayer structure according to claim 5.

10. A packaging container comprising the multilayer structure according to claim 5.

11. A retort package comprising the packaging container according to claim 10 filled with contents.

12. A method for producing the resin composition according to claim 1, the method comprising adding a phosphoric acid salt (B) which can form a hydrate to a resin composition comprising an ethylene-vinyl alcohol copolymer (A) having an ethylene content of from 15 to 65 mol % and a saponification degree of at least 95 mol % and a conjugated polyene compound (C) having a boiling point of at least 150° C., and melt-kneading them.

13. The method for producing the resin composition according to claim 12, wherein the phosphoric acid salt (B) comprises a powder containing 97% by volume or more of particles having a particle diameter of 16 μm or less.

14. The method for producing the resin composition according to claim 12, wherein the phosphoric acid salt (B) comprises a powder containing 97% by volume or more of particles having a particle diameter of 13 μm or less.

15. The method for producing the resin composition according to claim 12, wherein the phosphoric acid salt (B) comprises a powder containing 97% by volume or more of particles having a particle diameter of 10 μm or less.

16. The method for producing the resin composition according to claim 12, the method further comprising a step of grinding the phosphoric acid salt (B) before the melt-kneading.

17. The method for producing the resin composition according to claim 12, the method further comprising a step of drying the phosphoric acid salt (B) before the melt-kneading.

18. The method for producing the resin composition according to claim 12, wherein the temperature during the melt-kneading is from 190 to 260° C.
